(19) United States
(12) Patent Application Publication
(10) Pub. No.: US 2014/0372414 A1
(43) Pub. Date: Dec. 18, 2014

(54) Multiple Parameter Graphical Display System and Method

(71) Applicant: ENERGY SERVICES ONLINE LIMITED, LONDON (GB)

(72) Inventors: Joseph K. Malinowski, London (GB); Lynton Morgan, Chicester (GB); Dominic Morgan, London (GB); Brendan Patterson, Worthing (GB); Jonathan Rogers, Tangmere (GB)

(21) Appl. No.: 14/300,437

(22) Filed: Jun. 10, 2014

Related U.S. Application Data
(60) Provisional application No. 61/835,557, filed on Jun. 15, 2013.

(51) Int. Cl. G06F 17/30

(52) U.S. Cl. CPC G06F 17/30554; G06F 17/30864
USPC 707/722

(57) ABSTRACT

A network based system for comparing options resulting from a query, the system comprising a computer accessible from at least one remote location, the computer being configured to provide a user interface, the user interface being capable of receiving query related information from the remote location. The computer is further capable of performing a query related to the query related information, and determine query results representing a plurality of options relating to the query, and form a representation graph representing the plurality of options, the representation graph having a plurality of data points, each data point representing at least one of the plurality of options, wherein the relative location of a data point within the presentation graph is determined in relation to the location of at least one other data point, the relation representing at least one parameter of the option, and to display the presentation graph. Optionally the systems displays additional information related to an option in response to mouse-hover, and activates a hyperlink when a data point is asserted.

### FIELD OF THE INVENTION

The invention relates generally to graphical user interfaces, and more specifically to a method and system for displaying information for evaluating between a plurality of choices.

### BACKGROUND OF THE INVENTION

Internet based commerce has become rampant, and the breadth of suggested products and services often overwhelms consumers trying to select the best option. Products offerings products and services, and oftentimes selection between the offerings is very confusing. Depending upon the field of the product or service various parameters may need to be considered while evaluating the relative merit of one offering or another. Sometimes, a single and relatively simple criteria is the sole issue. By way of example, if a specific product, such as a book, is searched, the total cost may be the only parameter to be considered, however even in such a simple case, other parameters may come into play such as availability and time of delivery, however those are relatively simple to present by utilizing a simple one dimensional table sorted according to the parameter of concern. Another example is the selection of a single product amongst a family of similar products. By way of example selecting a single engine oil amongst the oil offering of many manufacturers. Each manufacturer touts its own product as the best, and a variety of vendors offer different pricing for one or more of the products of that family. This is an example where besides the obvious price consideration, the consumer may look at reputation, reviews of the product, and the like. Such search becomes more time consuming. A parameter in such case may be the average satisfaction level reported by users, or a rating system based on expert experience.

Selecting travel or a service provider is even more complex. In flight selection the number of options is staggering where a change in a date, which may or may not be important to the traveler may change the price very significantly. Other travelers would consider travel time as the important parameter, and others yet would try and compare comfort, airport pair selection, and the like. Similarly, selecting a service provider such as a cellular phone provider, connectivity provider, energy provider, and the like, presents the user with a large number options, which change according to certain conditions. Analyzing such arrangements requires complex and time consuming work.

Many areas of endeavor developed specific tools for analyzing offerings, however when the number of parameters or the amount of data related to each offer is large, presenting the different options requires large screen areas. Sorting by a single parameter such as price will oftentimes not be sufficient, and presenting a large number of offerings may take many screens and scrolling until the user will find the offering that provides the right mixture for his/her needs. As a result users often compromise on a less than ideal offering, while an offering which better suits their need exists, unbeknown to them, farther down the list.

Online commerce web sites commonly attempt to concentrate the information provided to users, to avoid the need for continuous ‘wandering’ about a site. After a query is executed, present solutions provide long lists of options which may spread over several pages. In some cases a table such as a calendar, or a one or two parameter text table is provided in a single screen zone, however those options are severely limited due to readability issues. The user is required to move between different screens and/or screen zones in order to consider different options.

Certain price comparison websites claim to compare tens and even hundreds of thousands of available options, such as of 500,000 mobile (cell) phones and deals. Deals are grouped into high-level categories before a search can take place and a high-level category will typically return thousands of choices requiring hundreds of separate web pages to display the results, with each individual page requiring lengthy scrolling from top to bottom.

Present solutions arranged in long lists of products or services displayed over many screens also makes it extremely difficult for product providers with innovative products or services to get any meaningful representation if their products are not listed on the first few results. Moreover, certain web sites provide an option for vendors to increase their ranking and cause them to appear at the top of such lists, according to fees paid to the web site, rather than according to their actual merit, where better choices are hidden beyond many pages of lesser fitting options.

There is therefore a long felt, yet heretofore unmet, need for a method of presenting a plurality of deal offerings in a manner that will assist the user to screen the offerings within a single view. There is also a need to present such information reflecting user selected criteria.

### SUMMARY OF THE INVENTION

The different aspects of the present invention are directed to providing a graphical display method to ease comparison between a plurality of offerings, by displaying a qualitative graphical representation of the comparison results, on a single screen. A presentation graph is utilized to provide an easy visual representation of the comparison results, as a plurality of graph data points corresponding to respective offerings.

The term “presentation graph” as used in these specifications denotes a graphical representation, within a single displayed page, of a plurality of options reflecting pre set criteria, user selectable criteria, or a combination thereof. The options are represented by corresponding data points. A presentation graph is generally presented on a two dimensional screen, however the graphical data may be represented as simulated three dimensional space. However, it is important to differentiate the dimensionality of a presentation graph rather than the dimensionality of the actual surface it is represented thereupon, or the shape the graph takes. A dimension hereinafter, should be construed as relating to an actual or derived parameter being represented simultaneously by the presentation graph, and the dimensionality of the presentation graph is related to by the number of actual or derived parameters presented.

By way of non-limiting example, a bar graph may form a set of data points on two axes, but as the data points represent a single parameter, the graph is related to as a ‘one dimension’ graph. A scatter graph may be utilized to depict options in conjunction with two parameters and will be related to as having ‘two dimensions’. A simulated three dimensional cube or sphere, or a set of superimposed graphs may be utilized to represent options reflecting three parameters, and are considered as three dimensional graph. Other indications such as different colors, shading, and/or geometries of data points may be utilized to represent additional parameters, and thus add dimensions. However it is noted that not all dimensions represent a continuum. By way of example, different colors, shading, and/or geometries of data points may be used to draw attention to specific options that are of perceived special interest. Such special interest may represent options indicated as of interest by a user, options of interest dictated by the issue at hand (such as ‘highest value’, ‘lowest long term cost’, closest fit to original selection’, ‘currently used’, and the like), options which are highlighted due to advertisement, options most befitting a user defined criteria, and the like

Optionally the presentation graph is used in conjunction with a mouse-hover function, which should be construed as presenting additional information about the option associated with a data point when a pointer is placed over the data point, or the user otherwise acts on the data point in a predetermined way, such as long pause, tap, and the like. Such presentation may be in the form of a popup window, or by presenting the information in a dedicated portion of the screen.

Further optionally, data points in the presentation graph may form hyperlinks to more complete data about the option associated with the data point.

A presentation graph in accordance with the different aspects of the present invention provides the capability to present a compact ‘total query’ view, presenting the user with a graphical presentation in a single screen or a portion thereof, to see all the options which resulted from the query, and allowing the user to graphically compare and locate the option best suited to their specific needs. If the mouse-hover option, and/or the links are also provided, the user receives easy access to more pertinent information for one or more of the options presented within the presentation graph.

Therefore in one aspect of the invention, there is provided a method for comparing options resulting from a query, the method comprising receiving query related information in a server, the information being transmitted from a remote location via a data link. The remote location has a data display capable device such as a computer, graphics tablet, or any mobile terminal which is capable of displaying computer generated graphics. Most commonly such a device is capable of acting as HTTP web client. and performing the query. The query is performed either on a local database, using external databases such as search engines, ranking servers, and the like, or any combination thereof. The query results are determined and optionally analyzed. Either direct query results, the analysis results or their combination, form a plurality of options relating to the query. A presentation graph having at least one axis is then formed, either as graphics to be transmitted to the remote location, or as instructions used to form such graphics. By way of example, the instructions may be program instructions, or data used by a dedicated program. The presentation graph graphically representing the plurality of options, and having a plurality of data points, each data point representing at least one of the plurality of options. The relative location of a data point within the presentation graph is determined in relation to the location of at least one other data point along the axis, the relation representing at least one parameter of the option. In other words, the presentation graph provides at least a graphical representation of the relative merit of each data point to allow easy approximation of the options which form the query results. The presentation graph is then displayed at the remote location.

Optionally, the method further comprises a “mouse-hover”, i.e. displaying textual information related to one of the plurality of options, when a user indicates interest in one of the plurality of options by acting upon a data point representing the one option. Indicating interest depends on the platform and is a matter of technical choice. By way of example, in a computer with a graphical cursor, placing the cursor over the data point or a portion thereof may be considered as expressing interest, while in a tablet or other touch based screen touching or tapping a point may be considered as such ‘mouse-hover’.

Further optionally, the method may comprise the step of receiving a selection comprising a subset of options and displaying a presentation graph relating to at least one parameter of the subset. Therefore, by selecting a group of data points the options associated therewith may be analyzed, or simply displayed in a different presentation graph. Either common parameters may be displayed or the group may become a sub-query where the user selects at least one parameter to rank the selected options, in a second presentation graph. Notably the second presentation graph may utilize other parameters than the first graph.

In some embodiments, at least one data point is correlated with a hyperlink, and the method further comprises activating the hyperlink responsive to the user asserting the at least one data point. Similar to the mouse-hover function described above, asserting a hyperlink is done in a system dependent manner, which is a technical choice. For example in a mouse based computer, a mouse click may activate the hyperlink, while in a touch based display, a tap or double tap may assert the data point.

In some applications a single axis is sufficient, such as cost by way of example. In others more than a single axis is desired, and thus in certain embodiments the presentation graph comprises a plurality of axes. In some embodiments at least one of the plurality of axes is user definable. Furthermore, in some embodiments at least one of the axes represents a plurality of parameters related to the option, and in certain embodiments at least two of the plurality of parameters have relative weight which is defined by the user.

In some embodiments a first data point of the plurality of data points is depicted differently from at least a second data point of the plurality of data points based on at least one parameter different than the parameter or parameters represented by the axis. This offers an easy way of depicting discrete parameters of the option. By way of example in an online purchasing system, one color may be utilized to paint a data point which has free express shipping associated with the represented item, while another color may be utilized to represent standard shipping.

The presentation graph type may be of any desired graph presentation. By way of example, a bar graph, a line graph, a pie chart, a stacked graph, a divided bar graph, a spherical graph, a vector graph, a scatter graph, a cube graph, and any combination thereof. A stacked graph comprises a bar graph which presents a few parameters or options along the bar, while a divided bar graph utilizes a plurality of bars to represent several parameters of a single option.

In another aspect of the invention there is provided a method for comparing options resulting from a query on a user terminal. The method comprises navigating to an Internet web site from the user terminal, and providing query related information to the web site; receiving from the web site a presentation graph, or instructions to create such graph. By way of example, the presentation graph may be provided as a video image, or it may be provided as a group of executable instructions to a certain environment such as Java, directX, HTML, XML, and the like, the result of executing the instructions forms a presentation graph. The presentation graph may also be delivered as data to a specific application. The presentation graph represents plurality of options relating to the query. The method then comprises displaying the presentation graph, wherein the presentation graph graphically represents the plurality of options, the presentation graph having a plurality of data points, each data point representing at least one of the plurality of options, wherein the relative location of a data point within the presentation graph is determined in relation to the location of at least one other data point along the axis, the relation representing at least one parameter of the option, the presentation graph having at least one axis.

Yet another aspect of the invention is directed towards a network based system for comparing options resulting from a query to the system comprising a computer accessible from at least one remote location, the computer being configured to:

provide a user interface, the user interface being capable of receiving query related information from the remote location; perform a query related to the information, and determine query results representing a plurality of options relating to the query; form a presentation graph representing the plurality of options, the presentation graph having a plurality of data points, each data point representing at least one of the plurality of options, wherein the relative location of a data point within the presentation graph is determined in relation to the location of at least one other data point, the relation representing at least one parameter of the option; and, send the presentation graph for display in the remote location.

Options relating to different aspects may be combined to provide improved comparisons of the various options received from a query.

### SHORT DESCRIPTION OF DRAWINGS

The summary above, and the following detailed description will be better understood in view of the enclosed drawings which depict details of preferred embodiments. It should however be noted that the invention is not limited to the precise arrangement shown in the drawings and that the drawings are provided merely as examples.

FIG. 1 depicts a simplified framework environment in which aspects of the invention may operate.

FIG. 2 depicts a schematic block diagram of a sample server for carrying out an embodiment of the invention.

FIG. 3 depicts a schematic screen arrangement for a one-dimensional presentation graph.

FIG. 4 depicts a schematic screen arrangement for a two dimensional presentation graph.

FIG. 5 depicts a simplified flow diagram for a method according to an aspect of the invention.

FIG. 6 depicts an example screen allowing user selection of axes.

FIG. 7 depicts an example screen allowing the user to define relative weight of parameters for an axis.

FIG. 8 depicts a simplified flow diagram for an aspect of the invention, centered on user experience.

### DETAILED DESCRIPTION

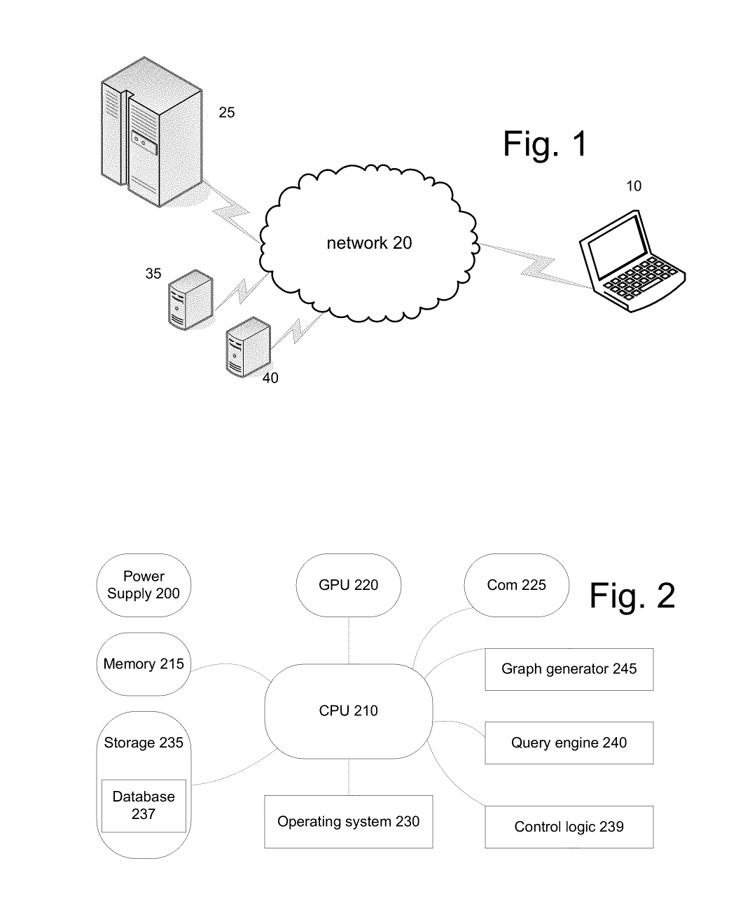

FIG. 1 represents a simplified framework in which different aspects of the invention are utilized. A terminal 10 is utilized by a user to present a query to a presentation server 25, via a communication network 20. The network may be a private or semi-private network, or the Internet. A plurality of users may be using the same presentation server. Optionally, other servers such as search engine 35 and ranking server 40 are also coupled to the network, or are otherwise accessible to the server 25.

FIG. 2 is a simplified schematic block diagram of an exemplary presentation server. At least one Central Processing Unit (CPU) 210 is utilized to execute different aspects of the invention, such as communicating with the network via a communications link module 225, collecting the data required for creating presentation graphs, creating the instructions required for creating a presentation graph on the user terminal, or providing instructions to an optional GPU 220 to create the presentation graph. The CPU communicates with memory 215 and optionally with storage 235, which may contain one or more databases 237. The presentation server has an operating system 230 which controls general aspects of its operation such as local user input, communication protocols, memory and storage management, and the like. The control logic 239 is a an executable program or dedicated hardware, which interfaces with the user requests, and allows the user to build a query. By way of example, HTML or Java may be utilized, however any desired language may be used. The control logic 239 is responsible for establishing the communication with the user, by displaying an initial screen, receiving certain details from the user, and transmitting responses, as well as for maintaining the sockets or other communication mechanisms open to warrant continuity of the communications. In many embodiments, an instance of the control logic or portions thereof will be launched for each user.

A query engine 240 is an executable program or dedicated hardware for responding to queries received over the communication link 225, and via an instance or instances of the control logic 239. The query engine frames the different aspects of the query, such as initial parameters, parameter selection by the user, and the like. Once the query is defined, the query engine executes the query against one or more information sources. By way of example the query engine may execute the query to locate information stored in the local database 237. However the query engine may also perform inquiries at other information sources such as one or more search engines, ranking servers, and the like. The query engine may also execute the query by retrieving information from websites that provide relevant information, and not utilize local storage at all.

The results of the query are transferred from the query engine 240 to the graph generator 245, which forms instructions forming the graph that is used as an output for the user. The output would be interpreted and displayed on the user terminal 10. In certain embodiments, a Graphics Processing Unit 220 may be utilized to deliver the presentation graph on the user terminal, and in certain embodiments the graph is sent to the user terminal as instructions that are interpreted by the user terminal and form the presentation graph on a display device at the user terminal. Power supply 200 is utilized to power different aspects of the server.

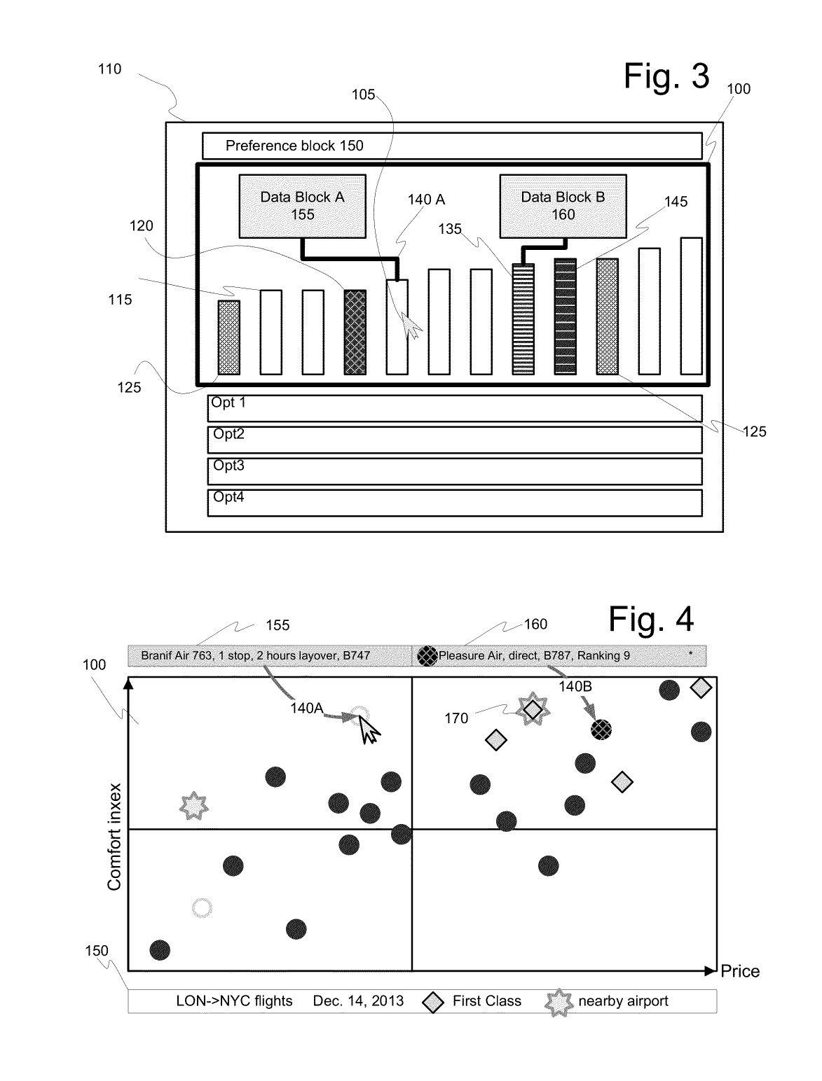

FIG. 3 depicts an example of a one dimensional presentation graph. The presentation graph 100 is displayed, together with other optional items, on screen 110. The graph is a simple bar graph, but the skilled in the art will readily recognize that other graph types may be utilized such as a line graph, pie graph, and the like. Each bar represents a single data point, which is associated with an option for consideration by the user. Optionally a specific preselected reference option may be permanently marked for a specific presentation graph. By way of example if the graph in the example represents an option for an energy supplier in a specific property, bar 135 may represent the current energy supplier to that property. Bar 135 is coupled with data block B 160. The data block 160 is utilized to display specific relevant information to ease the comparison process. Each of the other bars is a data point representing an option for the user to consider and compare with the current supplier. Ordinary data points are represented by non-patterned bars such as bar 115. Such presentation allows the user to see how they fair compared to other available options. Shaded or colored bars represent options of special interest. By way of example bars 125 may be ‘grayed out’, which indicates that they are not applicable to a specific search, but are presented for providing certain comparison information. Bars 120 and 145 are examples of highlighted data point, representing options of interest. By way example bar 120 may represent the lowest price available, by special shading or color, while option 145 is made to stand out since this option is a featured advertisement. In the depicted option, if the user places the mouse cursor 105 over a bar, Data Block A 155 is filled with information relating to the option associated with the bar, optionally with information that is similar in nature to the information presented in Data Block B 160 for easy comparison. Optionally, a line 140 is shown to clearly show to which bar the details in Data Block A relate to. If the user clicks the mouse or otherwise asserts the data point such as by tapping or pointing in a touch screen environment, the bar acts as a hyperlink and the user is directed to the full details of the option.

The depicted screen also indicates the problem which certain aspects of the invention assist solving. As the screen space is limited, there is only sufficient space to show a small number of options in detail. Thus while options Opt1-Opt4 are presented in more detail, the presentation graph allows shorthand assessment of the details presented in Data Block A, and offers easy approach to the full details of the selected option, via the hyperlink to the option details.

Optionally a preference block 150 is also provided, to display parameters related to the query, and further optionally to allow the user to easily change those parameters.

Thus, in the above example as relating to energy providers, a user would use a user terminal 10 to connect via the network 20 with the presentation server 25. An instant of the control logic 239 establishes communications with the user terminal and presents several questions to the user. Once the questions are answered and the control logic has sufficient information about the user query the query information is transferred to Query engine 240. The Query engine parses the query and finds the options that fit the required query criteria. The Query engine may utilize local information, such as the information stored in one or more databases directly accessible by the server. The Query engine may utilize other resources via the network. By way of example the Query engine may access the energy supplier web sites, utilize a search engine 35, compare reviews in a ranking server, and the like.

Once the Query engine has collected the required data it is transferred to Graph generator 245, which structures the graph for presentation to the user. The graph generator may stay aware of actions the user performs on the graph, or this duty may be delegated to another module, such as a program being executed on the user terminal.

FIG. 4 represents an example of a scatter graph being used as two dimensional presentation graph 100. It is however noted that several other parameters are shown, with certain discrete points. Only the presentation graph portion of the screen is shown. The presentation graph relates to flight selection. The horizontal axis represents price, however the vertical axis represents yet another optional aspect of the present invention. In that aspect a user may define an axis of the graph. By way of example certain users will value total flight time as the most important comfort parameter, while others will use the seat pitch or width as the most important parameters. However generally both would consider a stop with a layover as a disadvantage. The comfort index preferences of the user may be built during the initial data gathering by the control logic 239, and the Query engine may collect data related to the comfort index and assemble the query results with such data. The general parameters are shown by the Preference Block 150, and preference of comfort level may also be displayed (not shown). Similar to the example depicted in FIG. 3, the cursor lies over a point and the optional ‘mouse-hover’ feature causes data block A 155 to display information related to the flight option under the cursor, while data block B 160 displays another option. By way of example this option, denoted both by different color or shading and by line 140 B may represent the perceived highest value, or simply be an option which the user elected as a point of comparison. The skilled in the art would readily understand that more data blocks may be utilized.

Preferably, each data node which allows booking of the flight would serve as a hyperlink to more data, ability to buy the flight, and the like.

In the present example, two discrete values are also shown: seats that are in first class are depicted by a parallelogram, and flights to nearby airports are depicted by a star. Attention is drawn to the data point 170 which denotes both a different airport and a first class seat, to show an example of a combination of several parameters imparted to a single data point. It is noted however that the presentation graph as a whole may be considered as a two dimensional graph, with several discrete parameters depiction.

It will be apparent from the above examples that the presentation graph offers an easy comparison of the total number of options available as a result of a search from within a single screen. This presents a very significant improvement to the present comparison method between options, which requires many details, scrolling and/or switching between different screen pages, and the like.

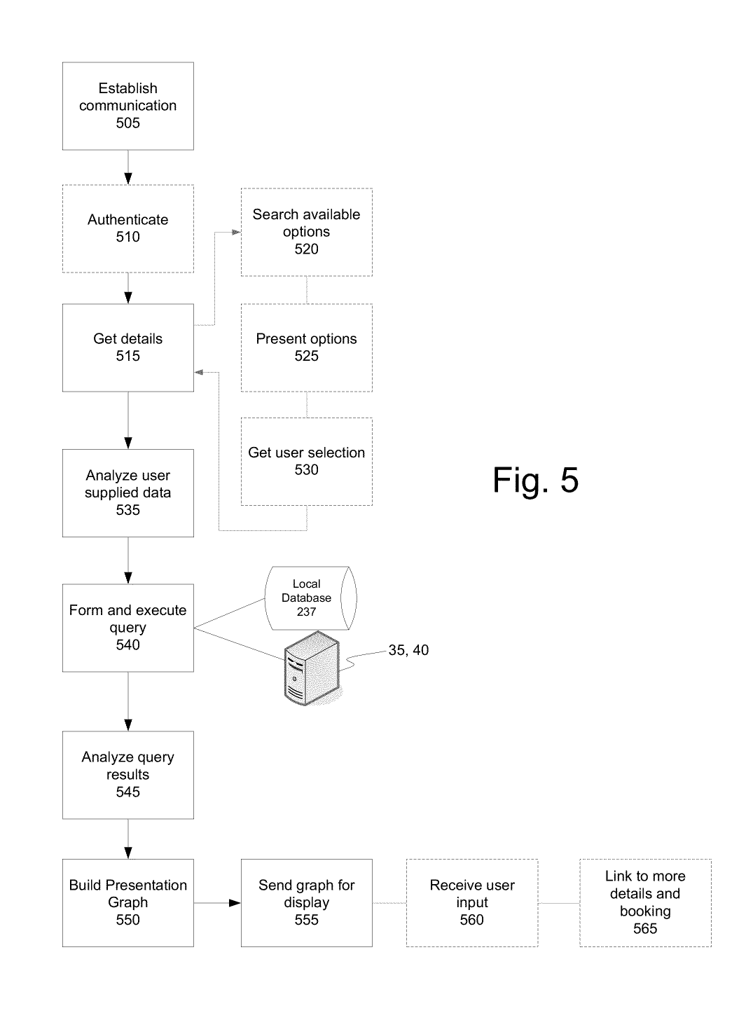

An exemplary operation of activity flow within a system embodying the invention is shown schematically in FIG. 5. The example is directed to a web site assisting a user to select energy providers and tariffs. Optional steps are shown in dashed lines.

The user establishes communications 505 from a user terminal 10 to a server 25 via the network 20. Optionally, the web site may authenticate the user 510 for access rights. The web site asks the user 515 for certain needed parameters, such as address, current provider, current expense or usage level, and optionally certain preferences. By way of example optional steps 520-530 are preformed, where the system searches available options 520 for the user . In the present example such options may include a list of suppliers in the market to the user address. The list of available options is presented to the user 525, and the user selects the preferred suppliers or a criteria for selecting a group of suppliers. The system may need to analyze 535 the user requirements and preferences prior to forming the query. If by way of example, the user current consumption qualifies for a special rate, using more than one supplier. The nature of the required parameters and the analysis will depend on the application at hand. The query is then formed and executed 540 utilizing any appropriate data source or sources, such as local database 237, and/or network servers 35, 40. The query results are analyzed 545 and a Presentation Graph is built 550 and sent 555 back to the user for display and/or storage. Optionally the user may select an option, the system accepts the user input 560, and links the user 565 to a page corresponding to his selection, where more details and/or purchase options may be presented.

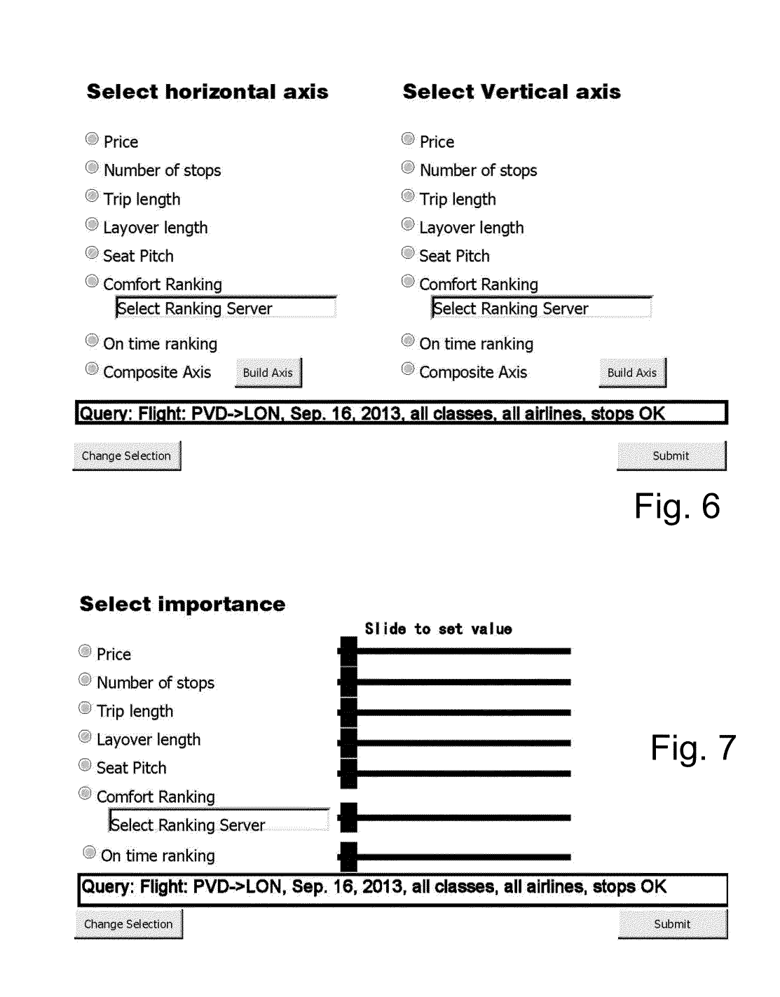

As the example above calls for a relatively simple option set, a relatively simple presentation, one dimension graph as presented in FIG. 3 may be utilized. However depending on the matter at hand, more complex presentation graphs may be formed. By way of example, FIG. 6 depicts an optional screen that may comprise a portion of step 515 for a web site providing flight booking options. Either before or after providing the initial flight details, the user is directed to a screen which allows selection of certain parameters for the different axes of the presentation graph. Thus, a user which values price and minimal flight time would select price and trip length as the main axes for the graph, while another user may select the comfort ranking for the flight, as provided by one or more servers utilizing user feedback, expert opinion, industry standards, and the like.

In certain embodiments the user may create a case-specific value system, and have the Presentation Graph represent such value system. If the user elects to have the presentation graph represent a composite axis which combines more than one parameter, the user asserts the ‘build axis’ button for the desired axis. The system then presents the user with a screen that provides for such axis. FIG. 7 represents an example of an optional axis building screen for the embodiment represented in FIG. 6. In FIG. 7 each of the parameters is given a weight selected by the user. When a presentation graph is created the axis represents the data points according to the axis defined by the user. Automatic scaling of the axis is preferably offered for such embodiments.

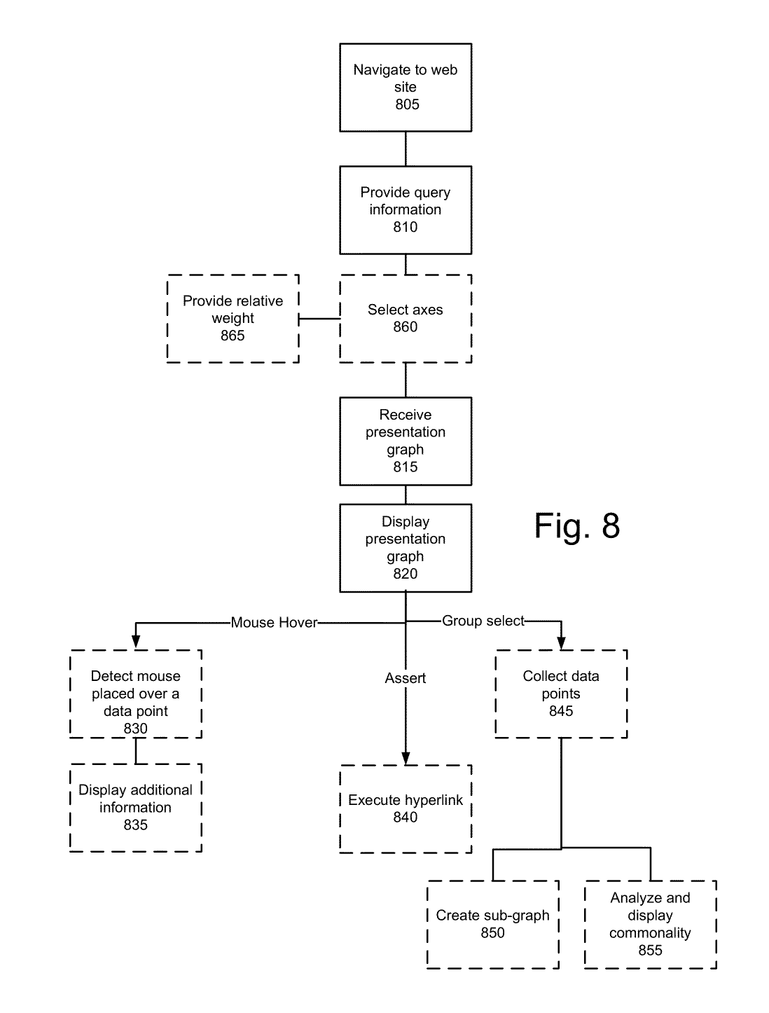

FIG. 8 is a simplified block diagram of a method viewed from a user standpoint, where the user navigates 805 to an Internet site such as a web site or a dedicated server. The user than provides 810 some information required to form a query. The information is dictated by the nature of the service provided. By way of a non-limiting example, in an online purchasing web site the information will relate to the item the user would like to purchase, in a travel web site it will relate to departure and destination, and dates of travel, and in an energy price comparison web site it will relate to the user's current use, address, and the like. Once the user finishes providing the data, the web site executes a query which produces a plurality of options, which relate to the query. In relation to the examples provided above, the options may relate to a plurality of vendors and prices for the item the user inquired about, a travel web site may provide a number of options for the requested travel requirements, and an energy price comparison web site would provide a list of available providers, and optionally specific package deals, prices, and the like.

The web site forms a presentation graph to represent the options and sends it to the user terminal. The presentation graph may be provided as a video image, or it may be provided as a group of executable instructions. By way of example, the graph may be formed and delivered as a group of Java instructions, DirectX or other graphical language, HTML, XML and other web languages, a script, and the like. Executing the instructions on the user terminal or an intermediate computer, forms a displayable presentation graph. Alternatively the user may utilize a specialized applet directed to presenting a query to the internet site and receiving data therefrom, and in such case the applet contains the code required to generate the presentation graph from data delivered by the Internet site.

The presentation graph representing a plurality of options relating to the query is received 815 at the user terminal, and displayed thereupon 820. The presentation graph, having at least one axis, graphically representing the plurality of options as a plurality of data points, where each data point represents at least one of the plurality of options. The relative location of a data point within the presentation graph is determined in relation to the location of at least one other data point along the axis, the relation representing at least one parameter of the option.

Several paths may optionally be followed and are depicted as options. The path denoted as ‘mouse-hover’ is taken when the user indicates interest in a specific option 830. By way of example this may be done by placing a pointer over the data pointed, or touching the data point in touch based devices. In response, additional information is displayed 835. The additional information may be graphical, textual, or a combination thereof. The additional information may be displayed as a popup window, or in a specific zone of the display.

The optional path labeled “Assert” is taken if the user asserts a data point. Asserting occurs with another action taken by the user to indicate a data point of interest. By way of example, asserting may occur by a mouse click, a double tap, or a menu option. When the user asserts a node, a hyperlink associated with the option is activated 840, and the user terminal is directed to the relevant link, where additional information may be presented, such as more complete details, special deal information, options to purchase the item to which the data point relates, and the like.

The path labeled “group select” is taken in response to the user selecting a group of data points, and then electing an action. Some embodiments allow more than a single action, and in some embodiments the act of selection itself invokes an action. One such optional action may be considered as a form of ‘zoom’ which allows the user to consider only a subset of the options received by the original query. Selection may occur based on selecting individual data points one after another, or as a group such as by ‘point and drag’ operations. Group select may also happen according to a parameter, such as “show all items with cost less than $30”. After a group is selected and the user elects to concentrate on the subset, the selected data points are identified and “collected” 845 into a subset. The subset is then acted upon by the selected action, where in the ‘zoom’ option the selection is transformed into a presentation graph 850 which can be displayed independently. In an alternative operation the selected data points are analyzed and common parameters are identified and displayed 855, such as “All selected points ranked 5 or higher”.

In certain embodiments, the user may select 860 the parameters which are represented by the presentation graph axes. If a composite axis is selected, the user may be presented with the option to provide 865 relative weight to the selected parameter which forms the axis.

Yet another example for either asserting or indicating interest for activating a hyperlink or mouse-hover’ is using gestures either on a touch sensitive device, or by utilizing a gesture sensitive device such as Microsoft Kinect®, by voice commands, and the like.

The skilled in the art would readily recognize that the examples provided herein are provided for easy understanding of the different aspects of the invention, and that the invention may be utilized in other comparison applications, such as hotel, car rental, price comparison and or price/quality comparison for specific items, comparison of options within a family of items, real estate, music and movie ranking, restaurants, hotels, and the like.

The skilled in the art would recognize that division of the programs described herein is provided for clarity and brevity of the explanation, and that the boundaries described between blocks are somewhat arbitrary and should be considered as an example. By way of example the functionality of the different elements may be divided differently therebetween, several of the depicted modules may be integrated into each other, the presentation server may be a standalone server variety or a distributed server comprising several computers, and the like.

It will be appreciated that the invention is not limited to what has been described hereinabove merely by way of example. While there have been described what are at present considered to be the preferred embodiments of this invention, it will be obvious to those skilled in the art that various other embodiments, changes, and modifications may be made therein without departing from the spirit or scope of this invention and that it is, therefore, aimed to cover all such changes and modifications as fall within the true spirit and scope of the invention, for which letters patent is applied.

What is claimed is:

1. A method for comparing options resulting from a query, the method comprising:
receiving query related information;
performing the query;
determining query results representing a plurality of options relating to the query;
forming a representation graph having an axis, the presentation graph graphically representing the plurality of options, the representation graph having a plurality of data points, each data point representing at least one of the plurality of options, wherein the relative location of a data point within the presentation graph is determined in relation to the location of at least one other data point along the axis, the relation representing at least one parameter of the option; and,
displaying the presentation graph.

2. A method as claimed in claim 1, further comprising the step of displaying textual information related to one of the plurality of options, when a user indicates interest in one of the plurality of options by acting upon a data point representing the one option.

3. A method as claimed in claim 1, further comprising the step of analyzing options represented by a plurality of the data points and displaying common parameters to the analyzed options, when a user indicates interest in the plurality of options by acting upon a data point representing the options.

4. A method as claimed in claim 1, further comprising the step of receiving a selection comprising a subset of options and displaying a presentation graph relating to at least one parameter of the subset.

5. The method as claimed in claim 1, wherein at least one data point is correlated with a hyperlink, and wherein the method further comprises activating the hyperlink responsive to the user asserting the at least one data point.

6. A method as claimed in claim 1, wherein the presentation graph has a plurality of axes.

7. A method as claimed in claim 5, wherein at least one of the plurality of axes is user definable.

8. A method as claimed in claim 6, wherein the at least one axis represents a plurality of option parameters.

9. A method as claimed in claim 7, wherein at least two of the plurality of parameters have relative weight which is defined by the user.

10. A method as claimed in claim 1, wherein the axis is user definable.

11. A method as claimed in claim 1, wherein the axis represents a plurality of option parameters.

12. A method as claimed in claim 1, wherein a first data point of the plurality of data points is depicted differently from at least a second data point of the plurality of data points based on at least one parameter different than the parameter or parameters represented by the axis.

13. A method as claimed in claim 1, wherein the presentation graph type is selected from a list consisting of a bar graph, a line graph, a pie chart, a stacked graph, a divided bar graph, a spherical graph, a vector graph, a scatter graph, a cube graph, and any combination thereof.

14. A method for displaying options resulting from a query on a user terminal, the method comprising:
navigating to an Internet web site;
providing query related information;
receiving from the Internet web site a presentation graph, or instructions therefore, the presentation graph representing a plurality of options relating to the query;
displaying the presentation graph, wherein the presentation graph graphically representing the plurality of options, the presentation graph having a plurality of data points, each data point representing at least one of the plurality of options, wherein the relative location of a data point within the presentation graph is determined in relation to the location of at least one other data point along the axis, the relation representing at least one parameter of the option, the presentation graph having at least one axis.

15. A method as claimed in claim 14, further comprising the step of displaying textual information related to one of the plurality of options, when a user indicates interest in one of the plurality of options by acting upon a data point representing the one option.

16. A method as claimed in claim 14, further comprising the step of analyzing options represented by a plurality of the data points and displaying common parameters to the analyzed options, when a user indicates interest in the plurality of options by acting upon a data point representing the options.

17. A method as claimed in claim 14, further comprising the step of receiving a selection comprising a subset of options and displaying a presentation graph relating to at least one parameter of the subset.

18. The method as claimed in claim 14, wherein at least one data point is related with a hyperlink, and wherein the method further comprises activating the hyperlink responsive to the user asserting the at least one data point.

19. A network based system for comparing options resulting from a query the system comprising:
a computer accessible from at least one remote location;
the computer being configured to:
provide a user interface, the user interface being capable of receiving query related information from the remote location;
perform a query related to the query related information, and determine query results representing a plurality of options relating to the query;
form a representation graph representing the plurality of options, the representation graph having a plurality of data points, each data point representing at least one of the plurality of options, wherein the relative location of a data point within the presentation graph is determined in relation to the location of at least one other data point, the relation representing at least one parameter of the option; and,
send the presentation graph for display in the remote location.

20. The system as claimed in claim 19, wherein the computer is further configured, when the user indicates interest in one of the plurality of options by acting upon a data point representing the one option, to display data related to the one option.

21. A method as claimed in claim 1, further comprising the step of analyzing options represented by a plurality of the data points and displaying common parameters to the analyzed options, when a user indicates interest in the plurality of options by acting upon a data point representing the options.

22. A method as claimed in claim 19, further comprising the step of receiving a selection comprising a subset of options and displaying a presentation graph relating to at least one parameter of the subset.

23. The method as claimed in claim 19, wherein at least one data point is related with a hyperlink, and wherein the method further comprises activating the hyperlink responsive to the user asserting the at least one data point.
